(19) United States
(12) Patent Application Publication
(10) Pub. No.: US 2003/0181546 A1
(43) Pub. Date: Sep. 25, 2003

(54) Curable composition and curable mortar composition

(76) Inventors: Rainer Hettich, Munich (DE); Armin Pfeil, Kaufering (DE); Thomas Burgel, Landsberg am Lech (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/391,303

(22) Filed: Mar. 18, 2003

(30) Foreign Application Priority Data
Mar. 19, 2002 (DE) 102 12 067.6

(51) Int. Cl. C08F 2/44

(52) U.S. Cl. 524/2; 524/533; 524/650; 526/227; 526/89; 526/217

(57) ABSTRACT

The invention is accomplished with a curable composition, which contains a resin component A with a subsidiary component a, a resin, which can be polymerized by free radicals, and a curing agent component B with a subsidiary component b, a peroxide curing agent. Before use of the curable composition, the components A and B are kept spatially separated and curing takes place only after components A and B have been mixed. To improve such curable compositions, it is proposed that a subsidiary component c, the leuco form of a dye, especially of a triphenylmethane dye, be added to component A. By following such a procedure, it is achieved that the peroxide activity and the progress of the mixing are monitored simultaneously without delaying the curing of the composition.

### FIELD OF THE INVENTION

The present application relates to a curable composition of the type named in the introductory portion of claim 1, as well as to a curable mortar composition of the type named in the introductory portion of claim 8. Such compositions may or may not be reinforced, can be cross-linked and have a very broad area of use. They can be used in casting, impregnating, puttying and spraying methods in the electronics industry, in container construction, in the building sector, in ship construction, in the motor vehicle industry, etc., for coatings and connections. Molded parts of different types and for different purposes can be produced from reinforced compositions by laying up, pressing and fiber spraying methods and the like.

### BACKGROUND INFORMATION AND PRODUCTION ART

Such compositions can, however, also be used for mortar compositions. Mortar compositions of the type described above are used, for example, for fastening anchoring means, such as anchor rods and the like, in boreholes.

The curable compositions are understood to be two-component resin systems, which contain, on the one hand, one or more curable components, which are present separately or in admixture and comprise a resin, and, on the other, a curing agent component. For evaluating and controlling the mixing quality, it is possible to add a dye to one component. After the mixing, this dye must then be distributed uniformly in the composition. With this method, however, it is not possible to recognize when the peroxide, which is required as curing agent, has lost its activity because its shelf life has been exceeded.

U.S. Pat. No. 3,390,121 discloses a dye indicator for resins, for which diphenylamine compounds, when mixed with peroxides, form a color, which disappears again when the resins are cured and can be used to check the mixing

It is, however, a disadvantage here that the diphenylamine compounds retard the curing reaction, so that the longer curing times are required. Furthermore, low-temperature curing is not possible with such a mixture, so that the range of uses for such mixtures is limited.

### OBJECT OF THE INVENTION

It is therefore an object of the present invention to make available a curable composition, which avoids the disadvantages described and offers a good indication of the mixing.

### SUMMARY OF THE INVENTION

This objective is accomplished by the measures named in claim 1, which have the following, special significance.

The special feature of the present invention accordingly consists therein, that the curable composition, which comprises a resin component A with a subsidiary component a.), namely a resin, which can be polymerized by free radicals, and a curing agent component B with a subsidiary component b.), namely a peroxide curing agent and for which the components A and B are kept spatially separated and curing is started only after components A and B are mixed, contains a subsidiary component c.), the leuco form of a dye, especially a triphenylmethane dye, in component A. The following advantages are achieved by this measure:

the peroxide activity and the progress of the mixing can be monitored simultaneously without retarding the curing, since the leuco form of a triphenylmethane dye does not have a retarding activity,

the color indication is independent of the heat of reaction,

the curable composition can be processed even at low temperatures without lessening the color indication.

The subsidiary component a.) is, for example, a resin from the group comprising the unsaturated polyester resins, epoxy acrylate resins, urethane-forming epoxide resins and vinyl ester urethane resins.

Such epoxy acrylate is and vinyl ester resins are known, for example, from the DE 32 26 602, the DE 36 17 702 and the DE 39 40 309.

As polyesters, the esterification products of unsaturated and saturated polycarboxylic acids polyalcohols are contained. As unsaturated polycarboxylic acids, mostly maleic acid or maleic anhydride and fumaric acid are used for this purpose and, as saturated polycarboxylic acid, mostly o-phthalic acid, iso-phthalic acid, tetrahydrophthalic acid, HET acid, adipic acid and the like are use. Examples of polyalcohols are ethylene glycol, 1,3-propylene glycol, neopentyl glycol and 1,3-butylene glycerin.

The unsaturated polyester resins generally are contained in solutions in reactive (copolymerizable) solvents. These may be monovinyl compounds as well as polyfunctional, polymerizable compounds. The most important, reactive monomer used (reactive diluent) is styrene. In addition to or instead of this reactive diluent, vinylic monomers, such as (meth)acrylic acid, (meth)acrylic acid derivatives, especially (meth)acrylate esters, such as t-butyl acrylate, hydroxyethyl methacrylate, etc., or compounds, which have at least one ally group, such as diallyl phthalate and triallyl cyanurate, can also be used. As polyfunctional and therefore cross-linking compounds, divinyl benzene, N,N-divinyl urea, N,N-divinyl cyanamide or, once again, (meth)acrylate esters, such as butylene glycol dimethacrylate, ethylene glycol dimethacrylate or allyl compounds, especially allyl esters of carboxylic acids, such as diallyl phthalate, diallyl maleate, diallyl fumarate and strongly cross-linking agents, such as trimethylolpropane trimethacrylate or triethyl cyanurate may be contained.

The shelf life of the unsaturated polyester resins end of the compositions, optionally containing cross-linking agents, is limited and time-dependent and temperature-dependent. After some time, gelling occurs after a corresponding increase in viscosity, which interferes with the processing. To avoid premature curing, which occurs in the absence of catalysts, inhibitors, such as phenol derivatives, such as t-butyl catechol, quinones, hydroquinones, phosphite esters, ammonium salts, sulfur, iodine, organosilicon compounds, etc., may be added.

The compositions may or may not be reinforced. The usual additives, mainly on a mineral basis, including fibers such as fiberglass, may be contained.

The use of cross-linking agents of a different type, such as isocyanates, is not in any way precluded.

Furthermore, conventional stabilizers, such as materials from the phenothiazine group, may be used.

Advantageously, a subsidiary component d.), namely an accelerator from the group of aromatic amines, is also contained in component A. By these measures, an acceleration of the reaction can be achieved. Suitable accelerators are, for example, diethylaniline, dimethyl-p-toluidine, and di-iso-propylol-p-toluidine, to mention but a few from the group of aromatic amines. The amines generally are used in amounts of 0.5 to 3% by weight, based on the unsaturated polyester.

In addition, according to claim 3, the subsidiary component c.) can also function as accelerator. Due to this measure, the acceleration of the reaction depends then not only on the content of subsidiary components d.) in component A, but also on the content of subsidiary components c.). The component c.), the leuco form of a triphenylmethane dye, can also be the only accelerator in component A, so that it is possible to do completely without accelerator component d.).

According to claim 4, the subsidiary components c.) and d.) can be present in the following percentages, based on the total weight of the subsidiary components c.) and d.) in component A:

Subsidiary component c.) in an amount of 0.01 to 100% by weight

Subsidiary component d.) in an amount of 99.99 to 0% by weight.

According to claim 5, it may be advantageous if the total percentage of subsidiary components c.) and d.) in component A is 0.1 to 4% by weight, based on component A.

According to claim 6, the subsidiary component b.) of component B may be an organic peroxide. Preferably, such an organic peroxide is taken from the group of diazyl peroxides. A preferred mixture, may, for example, contain dibenzoyl peroxide, cumene hydroperoxide bis(4-chlorobenzoyl)peroxide, t-butyl hydroperoxide, ketone peroxides, such as methyl ethyl ketone peroxide and cyclohexanone oxide, as well as alkyl peresters, such has t-butyl perbenzoate as subsidiary component b.).

Other peroxides or hydroperoxides may, however, also be used. The peroxides may be in the form of a powder, a paste or a liquid and are added in the usual amount.

It is a further object of the invention to make available a curable mortar composition, which avoids the use of disadvantageous, curable compositions.

Such a mortar composition is made available in conformity with claim 8 owing to the fact that the mortar contains a curable composition with the distinguishing features of claim 1. The inventive, curable mortar composition can also be processed at low temperatures, a color indicator showing the activity of the peroxide curing agent and, at the same time, indicating the progress of the mixing.

The inventive, curable mortar composition is intended to be used for dowelling and puttying purposes, especially in extrusion equipment. In addition to the curable compositions, which have already been described, the inventive, curable mortar composition may also contain fillers, such as quartz sand, or other mineral or non-mineral materials.

Further advantages and measures of the invention arise out of the dependent claims and the following examples, which are intended to explain to the invention without limiting it.

### EXAMPLE 1

To 15 parts of solid resin (vinyl ester resin here), ethylene glycol dimethacrylate (reactive diluent) and hydroxymethyl methacrylate (reactive diluent), 0.6 parts of dimethyl-p-toluidine (accelerator) and 0.1 parts of t-butyl catechol (inhibitor), 36 parts of quartz sand (filler), 15 parts of Portland cement (filler), as well as 3 parts of pyrogenic silica (thickening agent), 0.3 parts of leuco malachite green, having the formula below,

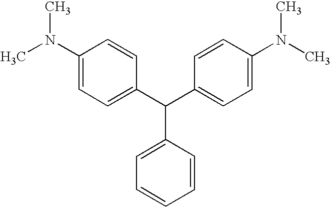

is added.

If the almost colorless composition is mixed in a static mixer with the B component, containing 40 parts of an aqueous dispersion of dibenzoyl peroxide (20 percent; curing agent), 57 parts of powdered quartz (filler) and 3 parts of pyrogenic silica (thickening agent, the mortar composition formed turns green, the progress of the mixing in the mixer being observed. The green coloration indicates the activity of the peroxide curing agent. The gelling time of the formulation given is about 2 minutes at room temperature.

### EXAMPLE 2

If the same mixture is processed at a temperature of −5° C., the gelling time is prolonged to 8.5 minutes. However, the color indication remains unchanged.

### EXAMPLE 3

A mixture, identical with that of Example 1, is prepared. However, instead of the leuco malachite green dye, it contains the leuco crystal violet dye as component c.), which has the structure

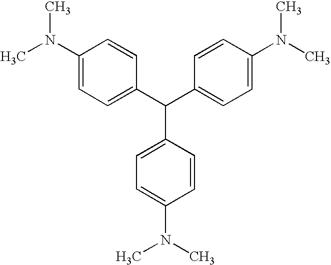

Upon mixing, the composition becomes violet, the coloration indicating the progress of the mixing and the activity of the peroxide curing agent. At room temperature, the gelling time of this formulation is also about 2 minutes.

### EXAMPLE 4

A mixture, identical with that of Example 1, is prepared. However, as component c.), it contains the a leuco indigo dye having the structure

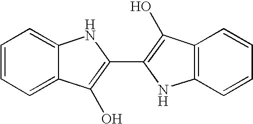

The mixture assumes the color shade of an indigo dye. The gelling time is prolonged slightly to about 4.5 minutes at 23° C. and 16 minutes at −5° C. and the color indication properties at room temperature correspond to those of Examples 1 and 3.

1. A curable composition, containing a resin component A with a subsidiary component,
a.) a resin, which can be polymerized by free radical polymerization and optionally is dissolved in reactive diluents
and a curing agent component B with a subsidiary component
b.) a peroxide curing agent,
the two components A and B being kept spatially separated from one another, curing being started only after the components A and B are mixed, wherein the component A comprises a subsidiary component c.), the leuco form of a dye, preferably of a triphenylmethane dye.

2. The curable composition of claim 1, wherein the component A contains a subsidiary component d.), an accelerator from the group of aromatic amines.

3. The curable composition of claim 1, wherein the subsidiary component c.), the leuco form of a dye, especially a triphenylmethane dye, is an accelerator.

4. The curable composition of claim 1, wherein the subsidiary component c.) is contained in an amount of 0.01 to 100 percent by weight and the subsidiary component d.) Is contained in an amount of 99.99 to 0 percent by weight in component A, based on the total weight of c.) and d.) in component A.

5. The curable composition of claim 1, wherein the total amount of subsidiary components c.) and d.) in component A is about 0.1 to 4 percent by weight, based on the weight of component A.

6. The curable composition of claim 1, wherein the subsidiary component b.) of component B is an organic peroxide.

7. The curable component of claim 1, wherein component b.) is present in an amount of 0.1 to 10 percent by weight, based on the total weight of the subsidiary components c.) and b.).

8. A curable mortar composition, especially for fastening anchoring means in boreholes, containing at least one curable composition and at least one curing agent, wherein the mortar contains a curable composition of claim 1.
